(19) United States
(12) Patent Application Publication
(10) Pub. No.: US 2023/0005044 A1
(43) Pub. Date: Jan. 5, 2023

(54) SALES INTELLIGENCE SYSTEM AND METHOD FOR GENERATING PERSONALIZED RECOMMENDATIONS FROM INTEGRATED DATASETS USING EXPLAINABLE AI

(71) Applicant: People Lens Inc., Cupertino, CA (US)

(72) Inventor: Yogi H Panjabi, Cupertino, CA (US)

(21) Appl. No.: 17/855,518

(22) Filed: Jun. 30, 2022

Related U.S. Application Data
(60) Provisional application No. 63/217,699, filed on Jul. 1, 2021.

(51) Int. Cl. G06Q 30/06; G06N 20/20

(52) U.S. Cl. CPC G06Q 30/0631; G06N 20/20

(57) ABSTRACT

A computer-implemented method and system for generating a recommendation that is personalized to achieve an enhanced sales outcome for a persona based on a multivariate artificial intelligence (AI) data model from an integrated dataset using explainable artificial intelligence (AI) models. The integrated dataset includes the people datasets, the organization datasets, and the customer datasets. one or more derived key drivers are derived from the multivariate AI data model. The derived key drivers and contextual sales activities are correlated with historical and real-time sales outcomes to train a first explainable AI model. The explainable sales outcomes are coupled with attributes, and activities of the persona to train a second explainable AI model. The second explainable AI model generates a recommendation that includes an automated reminder and an activity execution, to achieve the enhanced sales outcomes for the persona and the business.

### CROSS-REFERENCE TO PRIOR-FILED PATENT APPLICATIONS

This application claims priority from the U.S. provisional application No. 63/217,699 filed on Jul. 1, 2021, which is herein incorporated by reference.

### TECHNICAL FIELD

The present disclosure relates to the field of artificial intelligence for sales intelligence, and more specifically, to generating one or more personalized recommendations for a persona to attain a sales outcome, based on a multivariate artificial intelligence (AI) data model from an integrated dataset using explainable artificial intelligence (AI) models.

### DESCRIPTION OF THE RELATED ART

Sales intelligence involves the analysis of data that is typically derived from prospective customers to provide insights that facilitate the sales process for various stakeholders who are involved in the sales process. Research indicates that sales behavior insights have an opportunity to improve sales productivity by up to 20%.

Existing systems for sales intelligence rely on customer datasets (e.g. leads, calls, accounts, contacts, and deals) for sales insights. These customer datasets are lagging indicators that merely provide anecdotal information to confirm trends, but fail to enhance them. As a result, over 50% of sales representatives miss attaining their quota, and lack personalized input to enhance their performance. Although existing sales intelligence tools use advanced business intelligence on customer datasets from customer relationship management (CRM) tools and/or commission datasets, they fail to provide holistic insights that can be leveraged by customer-facing personas (e.g. sales representatives) to perform actions that lead to better sales outcomes.

Therefore, there arises a need to address the aforementioned technical drawbacks in existing approaches for sales analytics and sales intelligence.

### SUMMARY

In view of foregoing, there is provided a processor-implemented method for generating a recommendation that is personalized to achieve a sales outcome for a persona based on a multivariate data model from an integrated dataset using explainable artificial intelligence (AI) models. The method includes generating the multivariate data AI model using an integrated dataset by establishing relationships across the people datasets, organization datasets, and customer datasets. The method includes deriving one or more key drivers from the multivariate data AI model to obtain one or more derived key drivers. The method includes correlating one or more derived key drivers with historical sales outcomes and real-time sales outcomes to train a first explainable AI model. The method includes deriving one or more explainable sales outcomes from the first explainable AI model. The method includes correlating the one or more explainable sales outcomes with attributes of the one or more personas, and historical activities of the one or more personas to train a second explainable AI model. The method includes generating, using the second explainable AI model, the at least one recommendation that is personalized for the persona to achieve the enhanced sales outcomes. The at least one recommendation includes an automated reminder and an activity execution.

In some embodiments, the multivariate data model is generated by normalizing the integrated dataset to convert values of numeric columns in the integrated dataset to a common scale without distorting differences in a range of values.

In some embodiments, one or more derived key drivers include characteristics that are determined to be associated with high potential, high performance and aligned to business.

In some embodiments, enabling, using the first explainable AI model and the second explainable AI model, a comparison of present performance attributes and activities of the first persona with at least one of (i) past performance attributes of the first persona, (ii) attributes of a second persona, (iii) an average performance of a team, (iv) an average performance of an organization. and (v) an average performance of personas across organizations within an industry.

In some embodiments, the average performance of personas across organization within the industry is determined by aggregating performance of personas who work for customers of a sales intelligence provider who are from the industry after de-identification of the customers and personal information of the persona.

In some embodiments, the method further comprises correlating the people datasets, the organization datasets, and the customer datasets, with at least one of (a) explainable sales outcomes from the first explainable AI model or (b) enhanced sales outcomes from the second explainable sales outcomes to train the multi-variate AI data model.

In one aspect, there is provided a system for generating a recommendation that is personalized to achieve a sales outcome for a persona based on a multivariate data model from an integrated dataset using explainable artificial intelligence (AI) models. The system includes a memory that stores a set of instructions and a processor that is configured to execute the set of instructions, which when executed by the processor causes one or more functions of the system. The processor is configured to (i) generate the multivariate AI data model using an integrated dataset by establishing relationships across the people datasets, organization datasets, and customer datasets, (ii) derive one or more key drivers from the multivariate data AI model to obtain one or more derived key drivers, (iii) correlate one or more derived key drivers with historical sales outcomes and real-time sales outcomes to train a first explainable AI model, (iv) derive one or more explainable sales outcomes from the first explainable AI model, (v) determine one or more explainable sales outcomes from the first explainable AI model, (vi) correlate the one or more explainable sales outcomes with attributes of the one or more personas, and historical activities of the one or more personas to train a second explainable AI model, and (vii) generate, using the second explainable AI model, the at least one recommendation that is personalized for the persona to achieve the enhanced sales outcomes. The at least one recommendation includes an automated reminder and an activity execution.

In some embodiments, the multi variate data model is generated by normalizing the integrated dataset to convert values of numeric columns in the integrated dataset to a common scale without distorting differences in a range of values.

In some embodiments, one or more derived key drivers include characteristics that are determined to be associated with high potential, high performance and aligned to business.

In some embodiments, enabling, using the first explainable AI model and the second explainable AI model, a comparison of present performance attributes and activities of the first persona with at least one of (i) past performance attributes of the first persona, (ii) attributes of a second persona, (iii) an average performance of a team, (iv) an average performance of an organization, and (v) an average performance of personas across organizations within an industry.

In some embodiments, the average performance of personas across organization within the industry is determined 1w aggregating performance of personas who work for customers of a sales intelligence provider who are from the industry after de-identification of the customers and personal information of the persona.

In some embodiments, the processor is configured to further comprise correlating the people datasets, the organization datasets, and the customer datasets, with at least one of (a) explainable sales outcomes from the first explainable AI model or (b) enhanced sales outcomes from the second explainable sales outcomes to train the multi-variate AI data model.

In another aspect, there is provided one or more non-transitory computer-readable storage mediums storing one or more sequences of instructions, which when executed by one or more processors, causes a method for generating a recommendation that is personalized to achieve a sales outcome for a persona based on a multivariate data model from an integrated dataset using explainable artificial intelligence (AI) models. The method includes generating the multivariate data AI model using an integrated dataset by establishing relationships across the people datasets, organization datasets, and customer datasets. The method includes deriving one or more key drivers from the multivariate data AI model to obtain one or more derived key drivers. The method includes correlating one or more derived key drivers with historical sales outcomes and real-time sales outcomes to train a first explainable AI model. The method includes deriving one or more explainable sales outcomes from the first explainable AI model. The method includes correlating the one or more explainable sales outcomes with attributes of the one or more personas, and historical activities of the one or more personas to train a second explainable AI model. The method includes generating, using the second explainable AI model, the at least one recommendation that is personalized for the persona to achieve the enhanced sales outcomes. The at least one recommendation includes an automated reminder and an activity execution.

In some embodiments, the multivariate data model is generated by normalizing the integrated dataset to convert values of numeric columns in the integrated dataset to a common scale without distorting differences in a range of values.

In some embodiments, one or more derived key drivers include characteristics that are determined to be associated with high potential, high performance and aligned to business.

In some embodiments, enabling, using the first explainable AI model and the second explainable AI model, a comparison of present performance attributes and activities of the first persona with at least one of (i) past performance attributes of the first persona, (ii) attributes of a second persona, (iii) an average performance of a team, (iv) an average performance of an organization, and (v) an average performance of personas across organizations within an industry.

In some embodiments, the average performance of personas across organization within the industry is determined by aggregating performance of personas who work for customers of a sales intelligence provider who are from the industry after de-identification of the customers and personal information of the persona.

In some embodiments, the method further comprises correlating the people datasets, the organization datasets, and the customer datasets, with at least one of (a) explainable sales outcomes from the first explainable AI model or (b) enhanced sales outcomes from the second explainable sales outcomes to train the multi-variate AI data model.

The system and method for determining sales outcomes from integrated datasets using a machine learning model are provided. The system achieves an integration of organization, people, customer datasets, and contextual sales activities. The data integration in the system improves data redundancy, duplicity, and inconsistency. The system and method provide personalized recommendations for assisting managers and reps to address the key drivers with automated reminders to bring discipline to sales execution. The method empowers the sales reps, guiding behaviors, assisting them to contextualize and correlate their daily activities with sales outcomes (e.g. quota attainment). Also guiding their sales execution, with the intent to improve the topline by up to 20%. (As sales-behavior insights have the opportunity to improve sales outcomes by 20%).

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram that illustrates a system for generating a recommendation that is personalized to achieve enhanced sales outcomes for a persona based on a multivariate AI data model from an integrated dataset using explainable artificial intelligence (AI) models according to some embodiments herein;

FIG. 2 is an exemplary flow diagram of training a first explainable AI model to obtain one or more explainable sales outcomes according to some embodiments herein;

FIG. 3 is an exemplary flow diagram of training a second explainable AI model using one or more explainable sales outcomes from the first explainable AI model with persona attributes, and activities executed by the persona to obtain enhanced sales outcomes according to some embodiments herein;

FIG. 4 is a flow diagram that illustrates a method for generating at least one recommendation that is personalized to achieve enhanced sales outcomes for a persona based on a multivariate AI data model from an integrated dataset and explainable AI models according to some embodiments herein; and

FIG. 5 is a schematic diagram of a computer architecture in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned, there remains a need for an efficient system and method for generating a recommendation that is personalized for a persona based on a multivariate artificial intelligence (AI) data model from an integrated dataset using one or more explainable

AI models. Referring now to the drawings, and more particularly to FIGS. I through 5, where similar reference characters denote corresponding features consistently throughout the figures, preferred embodiments are shown.

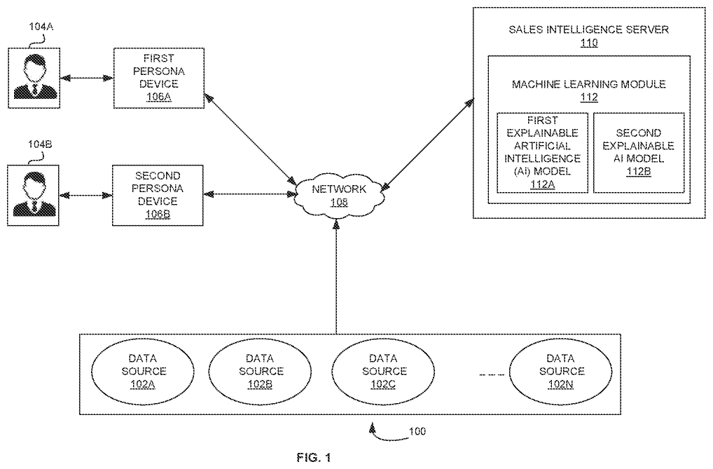

FIG. 1 is a block diagram that illustrates a system for generating at least one recommendation that is personalized to achieve enhanced sales outcomes for a persona based on a multivariate artificial intelligence (AI) data model from an integrated dataset and explainable AI models according to some embodiments herein. The system 100 includes one or more data sources 102A-N, a first persona device 106A, a second persona device 106B, and a sales intelligence server 110. The sales intelligence server 110 includes the machine learning module 112. A list of devices that are capable of functioning as the sales intelligence server 110, without limitation, may include one or more of a personal computer, a laptop, a tablet device, a smartphone, a mobile communication device, a personal digital assistant, or any other such computing device. In some embodiments, the first persona device 106A, and the second persona device 106B, without limitation, are selected from a personal computer, a laptop, a tablet device, a smartphone, a mobile communication device, and a personal digital assistant, or any other such computing device.

A first persona 104A is associated with the first persona device 106A. In some embodiments, the first persona 104A may be a customer-facing persona, for example, a sales representative or a salesperson. A second persona 104B is associated with the second persona device 106B. In some embodiments, the second persona 104B may be a sales manager, or, a sales executive, or, a vice president, or a higher consultant in the sales division. The sales intelligence server 110 may communicate with the first persona device 106A and the second persona device 106B through a network 108. In some embodiments, the network 108 is a wireless network. In some embodiments, the network 108 is a combination of the wired network and the wireless network. In some embodiments, the network 108 is the Internet. The data sources 102A-N may include data associated with customer datasets, organization datasets, and people datasets. The customer datasets may include data associated with leads, calls, accounts, contacts, deals, emails, prospects, opportunity management, deal management, call insights, sales management, sales insights, customer success, etc. The organization datasets include data associated with business strategy, objectives and key results (OKR), and productivity. The people datasets include data associated with hiring, diversity, well-being, engagement, competencies, attrition, learning and enablement, mentorship, and commission. In some embodiments, the data sources 102A-N may be enterprise systems, productivity applications (using proxy signals, employee data exhaust), and third-party data sources or sites.

The sales intelligence server 110 acquires one or more datasets from one or more data sources 102A-N. The one or more datasets include customer datasets, organization datasets, and people datasets. The sales intelligence server 110 integrates the acquired datasets to obtain an integrated dataset. in sonic embodiments, the sales intelligence server 110 integrates the acquired datasets using a data integration technique. The data integration reduces data redundancy, duplicity, and inconsistency.

The sales intelligence server 110 generates a multivariate AI data model from the integrated dataset by establishing relationships across the people datasets, organization datasets, and customer datasets. The sales intelligence server 110 derives one or more key drivers from the multivariate data model to obtain one or more derived key drivers. A key driver is a factor that affects the performance of an organization. The derived key drivers are useful to improve the performance of the organization. The derived key drivers and contextual sales activities may be any of objectives and key results (OKR), people priorities, productivity for the organization, hiring practices, learning, and enablement, competencies, mentorship, engagement, diversity, commission, well-being, attrition for people, prospect, opportunity management, deal management, time allocation, sales processes, sales discipline. The machine learning module 112 includes a first explainable AI model 112A and a second explainable AI model 112B. The first explainable AI model 112A is trained by correlating with one or more derived key drivers and contextual sales activities with historical sales outcomes and real-time sales outcomes to obtain one or more explainable sales outcomes. The second explainable AI model 112B is trained by correlating one or more explainable sales outcomes with attributes of the one or more personas, and historical activities of the one or more personas to obtain a trained second explainable AI model. The explainable sales outcomes may be any of win rate, sales cycle, deal size (annual contract value), quota attainment, and rep ramp times. The sales intelligence server 110 generates one or more recommendations that are personalized for the persona to achieve enhanced sales outcomes. The one or more recommendations include an automated reminder and an activity execution.

The first explainable AI model 112A and the second explainable AI model 112B provide the automated reminder and the activity execution to one or more personas, which are based on self-analysis, comparisons across individual high performers, teams, organizations and best in class companies in their industry, with the intent of enhancing sales outcomes of the persona.

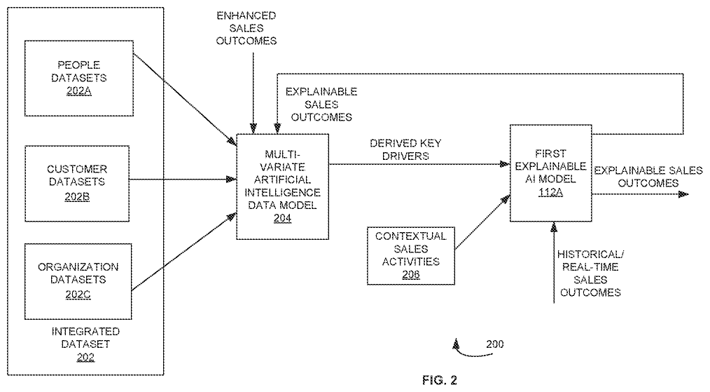

FIG. 2 is an exemplary flow diagram 200 of training a first explainable AI model 112A to obtain one or more explainable sales outcomes according to some embodiments herein. The flow diagram 200 includes integrating people datasets 202A, customer datasets 202B, and organization datasets at 202C to obtain an integrated dataset 202. The integrated dataset 202 includes the people datasets 202A, the customer datasets 202B, the organization datasets 202C. The flow diagram 200 includes generating a multi-variate AI data model 204 by establishing relationships across the people datasets, the organization datasets, and the customer datasets. The multi-variate AI data model 204 normalizes the integrated dataset 202 for one or more personas. The multi-variate AI data model 204 normalizes the integrated data to organize the integrated data efficiently for further analysis. The multi-variate AI data model 204 normalizes the integrated data to reduce data redundancy and improve data integrity. The data integration reduces data redundancy, duplicity, and inconsistency. The data integration may also include mapping of the integrated data, data transformation, and data cleansing. The flow diagram 200 includes deriving one or more key drivers to obtain one or more derived key drivers such as organization data (e.g. sales goals), customer data (e.g. prospect), and people data (e.g. learning and enablement) from the multi-variate AI data model 204. The integrated dataset 202 may be dynamic as the organization data (e.g. sales goals), customer data (e.g. prospect), people data (e.g. learning and enablement) are dynamic. Thereby, the integrated dataset 202 changes asynchronously over time as new data is available over a period of time. The one or more derived key drivers include characteristics that are determined to be associated with high potential, high performance, and alignment to the business. The one or more derived key drivers have a correlation with attaining explainable and enhanced sales outcomes. The exemplary flow diagram 200 includes correlating the one or more derived key drivers, and contextual sales activities 206 with historical/real-time sales outcomes to train the first explainable AI model 112A. The contextual sales activities 206 may be dynamic. The explainable sales outcomes that are generated are provided back to the multi-variate AI data model at 204 to improve the training of the first explainable AI model 112A in real-time. The enhanced sales outcomes are provided to the multi-variate AI data model 204 to improve the training of the first explainable AI model 112A in real-time.

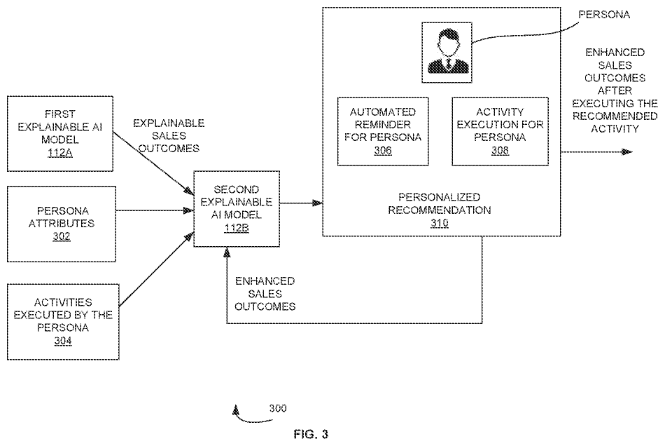

FIG. 3 is an exemplary flow diagram 300 of training a second explainable AI model using one or more explainable sales outcomes from the first explainable AI model with persona attributes, and activities executed by the persona to obtain enhanced sales outcomes according to some embodiments herein. The exemplary flow diagram 300 includes training the second explainable AI model 112B to obtain a second trained explainable AI model. The training includes correlating the explainable sales outcomes with the persona attributes 302, and activities executed by the persona 304. The explainable sales outcomes that are obtained from the first explainable AI model 112A are also provided as an input to train the second explainable AI model 112B. The persona attributes 302 may be, for example, data associated with hiring, diversity, competencies, attrition, learning and enablement, mentorship, level of experience, etc. The activities executed by the personas 304 may be, for example, scheduling meetings with customers, internal meetings with the team to complete objectives, completing training sessions, follow-up communication with customers, etc. The second trained explainable AI model generates one or more personalized recommendations 310. The one or more personalized recommendations 310 may include an automated reminder for the persona 306 and an activity execution for the persona 308. The automated reminder fir the persona 306 may include a specific action item for the persona to improve in a specific area and steps to implement the specified action item by executing the activity 308 when the automated reminder 306 is received. The automated reminder fir the persona 306 may be periodic, like weekly, monthly, or daily. The second explainable AI model 112B generates the enhanced sales outcomes for the persona once the persona completes the suggested activity. The enhanced sales outcomes for the persona are fed back to the first explainable AI model 112A and the second explainable AI model 112B in real-time. Hence, the training of the first explainable AI model 112A and the second explainable. AI model 112B may be improved further.

For example, the multi variate AI data model 204 establishes the derived key drivers (learning, assessment score on product knowledge) that impact sales outcomes. That means the derived key drivers (learning, assessment score on product knowledge) are key to improving selected sales outcomes. These derived key drivers (learning, assessment score on product knowledge) are coupled with the current assessment scores, sales activities for the persona, and are fed to the first explainable AI model 112A to determine that learning, assessment score impacts the win rate, a specific sales outcome that is particularly important for this persona and their business objectives.

This explainability of sales outcomes is then fed to the second explainable AI model 112B together with attributes of the personas (current learning, assessment score on product knowledge) and activities of the persona (learning records and participation in product training), to generate a personalized recommendation to the persona to improve their win rate by participating in product trainings improving their learning, assessment score for the selected product.

The second explainable AI model 112B generates a personalized recommendation to the persona, including an automated reminder to take the product training and the steps to participate in the training and improve the learning, assessment score on product knowledge, leading to an enhanced win rate over time for this persona.

In some embodiments, using the first explainable AI model 112A and the second explainable AI model 112B, present performance attributes and activities of the first persona 104A are compared with at least one of (i) past performance attributes of the first persona 104A, (ii) attributes of a second persona 104B, (iii) an average performance of a team, (iv) an average performance of an organization, and (v) an average performance of personas across organizations within an industry. The average performance of personas (sales reps) within the industry may be obtained by aggregating the performances of the personas (sales reps) who work for customers of the sales intelligence server 110, who are from the same industry, after de-identification of the customers and the persona's personal information.

Sales-behavior insights of one or more personas predict and enhance sales outcomes and sales productivity by up to 20%. In some embodiments, the sales ramp period of the first persona is accelerated by 20-50% using the predictable and enhanced sales outcome. The sales ramp-up period may be defined as the amount of time taken for a new sales hire to reach full productivity and begin providing value to the sales team. In some embodiments, the go-to-market (GTM) efficiency is improved by enhancing the return on investment (ROI) of learning and hiring initiatives and reducing the attrition of the first persona based on the predictable and enhanced sales outcome. In some embodiments, the revenue operations effectiveness is also accelerated due to the improvement of the sales performance of the first persona from grade B to grade A.

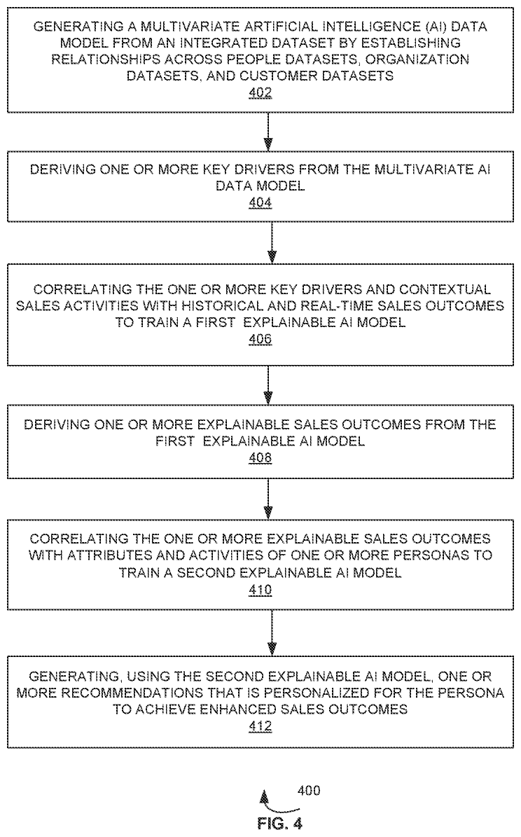

FIG. 4 is a flow diagram 400 that illustrates a method for generating at least one recommendation that is personalized to achieve enhanced sales outcomes for a persona based on a multivariate artificial intelligence (AI) data model from an integrated dataset and explainable AI models according to some embodiments herein. At step 402, the method includes generating the multi variate AI data model from an integrated data by establishing relationships across the people datasets, organization datasets, and customer datasets. The integrated dataset includes the people datasets, the organization datasets, and the customer datasets. At step 404, the method includes, deriving one or more key drivers from the multi variate AI data model to obtain one or more derived key drivers. At step 406, the method includes, correlating the one or more derived key drivers and contextual sales activities with historical sales outcomes and real-time sales outcomes to train a first explainable AI model. At step 408, the method includes, deriving one or more explainable sales outcomes from the first explainable AI model. At step 410, the method includes, correlating the one or more explainable sales outcomes with attributes of the one or more personas, and historical activities of the one or more personas to train a second explainable AI model. At step 412, the method includes, generating, using the second explainable AI model, at least one recommendation that is personalized for the persona to achieve the enhanced sales outcomes. In some embodiments, the at least one personalized recommendation includes an automated reminder and an activity execution. In some embodiments, the multivariate AI data model is generated by normalizing the integrated dataset to convert values of numeric columns in the integrated dataset to a common scale without distorting differences in a range of values.

In some embodiments, the multivariate data model is generated by normalizing the integrated dataset to convert values of numeric columns in the integrated dataset to a common scale without distorting differences in a range of values.

In some embodiments, one or more derived key drivers include characteristics that are determined to be associated with high potential, high performance and aligned to business.

In some embodiments, enabling, using the first explainable AI model and the second explainable AI model, a comparison of present performance attributes and activities of the first persona with at least one of (i) past performance attributes of the first persona, (ii) attributes of a second persona, (iii) an average performance of a team, (iv) an average performance of an organization. and (v) an average performance of personas across organizations within an industry.

In some embodiments, the average performance of the personas within the industry is determined by aggregating performance of personas who work for customers of a sales intelligence provider who are from the industry after de-identification of the customers and the persona's personal information.

In some embodiments, the method further comprising correlating the people datasets, the organization datasets, and the customer datasets, with at least one of (a) explainable sales outcomes from the first explainable AI model or (b) enhanced sales outcomes from the second explainable sales outcomes to train the multi-variate AI data model.

The embodiments herein may include a computer program product configured to include a pre-configured set of instructions, which when performed, can result in actions as stated in conjunction with the methods described above. In an example, the pre-configured set of instructions can be stored on a. tangible non-transitory computer readable medium or a

program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data. structures, and program modules represent examples of the program code means for executing steps of the methods disclosed herein. The particular sequence of such executable instructions or associated data structures represents examples of corresponding acts for implementing the functions described in such steps. The embodiments herein can include both hardware and software elements. The embodiments that are implemented in software include but are not limited to, firmware, resident software, microcode, etc. A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem, and Ethernet cards are just a few of the currently available types of network adapters.

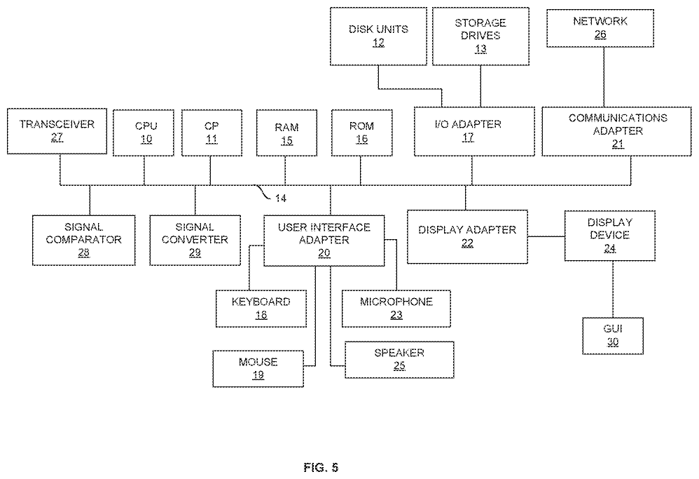

A representative hardware environment for practicing the embodiments herein is depicted in FIG. 5, with reference to FIGS. 1 through 4. This schematic drawing illustrates a hardware configuration of a sales intelligence server 110/a computer system/a first persona device 104A/a second persona device 104B in accordance with the embodiments herein. The first persona device 106A/the second persona device 106B includes at least one processing device 10 and a cryptographic processor 11. The special-purpose CPU 10 and the cryptographic processor (CP) 11 may be interconnected via system bus 14 to various devices such as a random access memory (RAM) 15, read-only memory (ROM) 16, and an input/output (I/O) adapter 17. The I/O adapter 17 can connect to peripheral devices, such as disk units 12 and tape drives 13, or other program storage devices that are readable by the system. The first persona device 106A/the second persona device 106B can read the inventive instructions on the program storage devices and follow these instructions to execute the methodology of the embodiments herein. The first persona device 106A/the second persona device 106B further includes a user interface adapter 20 that connects a keyboard 18, mouse 19, speaker 25, microphone 23, and/or other user interface devices such as a touch screen device (not shown) to the bus 14 to gather user input. Additionally, a communication adapter 21 connects the bus 14 to a data processing network 26, and a display adapter 22 connects the bus 14 to a display device 24, which provides a graphical user interface (GUI) 30 of the output data in accordance with the embodiments herein, or which may be embodied as an output device such as a monitorc or a printer.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

What is claimed is:

1. A processor-implemented method for generating at least one recommendation that is personalized to achieve enhanced sales outcomes for a persona based on a multivariate artificial intelligence (AI) data model from an integrated dataset using explainable artificial intelligence (AI) models, the method comprising:
generating a multivariate AI data model from an integrated dataset by establishing relationships across people datasets, organization datasets, and customer datasets, wherein the integrated dataset comprises the people datasets, the organization datasets, and the customer datasets;
deriving a plurality of key drivers from the multivariate AI data model to obtain a plurality of derived key drivers;
correlating the plurality of derived key drivers and contextual sales activities with historical sales outcomes and real-time sales outcomes to train a first explainable AI model;
deriving a plurality of explainable sales outcomes from the first explainable AI model;
correlating the plurality of explainable sales outcomes with attributes of the plurality of personas, and historical activities of the plurality of personas to train a second explainable AI model; and
generating, using the second explainable AI model, the at least one recommendation that is personalized for the persona to achieve the enhanced sales outcomes, wherein the at least one recommendation comprises an automated reminder and an activity execution,

2. The processor-implemented method of claim 1, wherein the multivariate AI data model is generated by normalizing the integrated dataset to convert values of numeric columns in the integrated dataset to a common scale without distorting differences in a range of values.

3. The processor-implemented method of claim 1, wherein the plurality of derived key drivers comprise characteristics that are determined to be associated with high potential, high performance, and aligned to business.

4. The processor-implemented method of claim 1, further comprising, enabling, using the first explainable AI model and the second explainable AI model, a comparison of present performance attributes and activities of the first persona with at least one of (i) past performance attributes of the first persona, (ii) attributes of a second persona, (iii) an average performance of a team, (iv) an average performance of an organization, and (v) an average performance of personas across organizations within an industry.

5. The processor-implemented method of claim 4, wherein the average performance of personas across organization within the industry is determined by aggregating performance of personas who work for customers of a sales intelligence provider who are from the industry after de-identification of the customers and personal information of the persona.

6. The processor-implemented method of claim 1, further comprising correlating the people datasets, the organization datasets, and the customer datasets, with at least one of (a) explainable sales outcomes from the first explainable AI model or (b) enhanced sales outcomes from the second explainable sales outcomes to train the multi-variate AI data model.

7. A system for generating a recommendation that is personalized to achieve a sales outcome for a persona based on a multivariate data model from an integrated dataset using explainable artificial intelligence (AI) models, wherein the system comprises:
a memory that stores a set of instructions;
a processor that is configured to execute the set of instructions and is configured to,
generate a multivariate. AI data model from an integrated dataset by establishing relationships across people datasets, organization datasets, and customer datasets, wherein the integrated dataset comprises the people datasets, the organization datasets, and the customer datasets;
derive a plurality of key drivers from the multivariate AI data model to obtain a plurality of derived key drivers;
correlate the plurality of derived key drivers and contextual sales activities with historical sales outcomes and real-time sales outcomes to train a first explainable AI model:
derive a plurality of explainable sales outcomes from the first explainable AI model;
correlate the plurality of explainable sales outcomes with attributes of the plurality of personas, and historical activities of the plurality of personas to train a second explainable AI model; and
generate, using the second explainable AI model, the at least one recommendation that is personalized for the persona to achieve the enhanced sales outcomes, wherein the at least one recommendation comprises an automated reminder and an activity execution.

8. The system of claim 7, wherein the multivariate AI data model is generated by normalizing the integrated dataset to convert values of numeric columns in the integrated dataset to a common scale without distorting differences in a range of values.

9. The system of claim 7, wherein the plurality of derived key drivers comprise characteristics that are determined to be associated with high potential, high performance and aligned to business.

10. The system of claim 7, further comprising, enabling, using the first explainable AI model and the second explainable AI model, a comparison of present performance attributes and activities of the first persona with at least one of (i) past performance attributes of the first persona, (ii) attributes of a second persona, (iii) an average performance of a team, (iv) an c average performance of an organization, and (v) an average performance of personas across organizations within an industry.

11. The system of claim 10, wherein the average performance of personas across organization within the industry is determined by aggregating performance of personas who work for customers of a sales intelligence provider who are from the industry after de-identification of the customers and personal information of the persona.

12. The system of claim 7, further comprising correlating the people datasets, the organization datasets, and the customer datasets, with at least one of (a) explainable sales outcomes from the first explainable AI model or (b) enhanced sales outcomes from the second explainable sales outcomes to train the multi-variate AI data model.

13. One or more non-transitory computer-readable storage mediums storing one or more sequences of instructions, which when executed by one or more processors, causes a method for dynamically updating a project plan using natural language processing and an artificial intelligence (AI) model performing steps of:
generating a multivariate AI data model from an integrated dataset by establishing relationships across people datasets, organization datasets, and customer datasets, wherein the integrated dataset comprises the people datasets, the organization datasets, and the customer datasets;
deriving a plurality of key drivers from the multivariate AI data model to obtain a plurality of derived key drivers;
correlating the plurality of derived key drivers and contextual sales activities with historical sales outcomes and real-time sales outcomes to train a first explainable AI model;
deriving a plurality of explainable sales outcomes from the first explainable AI model;
correlating the plurality of explainable sales outcomes with attributes of the plurality of personas, and historical activities of the plurality of personas to train a second explainable AI model; and
generating, using the second explainable AI model, the at least one recommendation that is personalized for the persona to achieve the enhanced sales outcomes, wherein the at least one recommendation comprises an automated reminder and an activity execution.

14. The one or more non-transitory computer-readable storage mediums storing one or more sequences of instructions, which when executed by one or more processors, causes the method of claim 13, wherein the multivariate AI data model is generated by normalizing the integrated dataset to convert values of numeric columns in the integrated dataset to a common scale without distorting differences in a range of values.

15. The one or more non-transitory computer-readable storage mediums storing one or more sequences of instructions, which when executed by one or more processors, causes the method of claim 13, wherein the plurality of derived key drivers comprise characteristics that are determined to be associated with high potential, high performance, and aligned to business.

16. The one or more non-transitory computer-readable storage mediums storing one or more sequences of instructions, which when executed by one or more processors, causes the method of claim 13, further comprising, enabling, using the first explainable AI model and the second explainable AI model, a comparison of present performance attributes and activities of the first persona with at least one of (i) past performance attributes of the first persona, (ii) attributes of a second persona, (iii) an average performance of a team, (iv) an average performance of an organization, and (v) an average performance of personas across organization within an industry.

17. The one or more non-transitory computer-readable storage mediums storing one or more sequences of instructions, which when executed by one or more processors, causes the method of claim 16, wherein the average performance of personas across organization within the industry is determined by aggregating performance of personas who work for customers of a sales intelligence provider who are from the industry after de-identification of the customers and personal information of the persona.

18. The one or more non-transitory computer-readable storage mediums storing one or more sequences of instructions, which when executed by one or more processors, causes the method of claim 13, further comprising correlating the people datasets, the organization datasets, and the customer datasets, with at least one of (a) explainable sales outcomes from the first explainable AI model or (b) enhanced sales outcomes from the second explainable sales outcomes to train the multi-variate AI data model.
